(19) United States
(12) Patent Application Publication
(10) Pub. No.: US 2026/0243396 A1
(43) Pub. Date: Aug. 20, 2026

(54) EMERGENCY LIGHTING DEVICE WITH DETACHABLE END CAPS

(71) Applicant: Xiamen PVTECH Co., Ltd., Xiamen (CN)

(72) Inventors: Dejia Li, Xiamen (CN); CHUN MING LIU, Xiamen (CN); LIANGLIANG CAO, Xiamen (CN); FUXING LU, Xiamen (CN)

(73) Assignee: Xiamen PVTECH Co., Ltd., Xiamen (CN)

(21) Appl. No.: 19/273,164

(22) Filed: Jul. 18, 2025

(30) Foreign Application Priority Data
Feb. 14, 2025 (CN) 202510165992.1

(51) Int. Cl. F21K 9/272; F21K 9/278; F21V 23/04; F21Y 103/10; F21Y 115/10

(52) U.S. Cl. CPC F21K 9/272; F21K 9/278; F21V 23/04; F21Y 2103/10; F21Y 2115/10

(57) ABSTRACT

An emergency lighting device with detachable end caps includes a tube body, two end caps, an input circuit and a load. The end caps are respectively disposed at two ends of the tube body. Each of the end caps includes a cylindrical body connected to the tube body and a cover detachably mounted on the cylindrical body. The input circuit has a first pin, a second pin, a third pin, and a fourth pin. The first pin, the second pin, the third pin, and the fourth pin are respectively disposed on the two end caps and connected to an external power source. The load is disposed inside the tube body and connected to the input circuit.

### BACKGROUND OF THE INVENTION

### 1. FIELD OF THE INVENTION

The present invention relates to a lighting device, in particular to an emergency lighting device with detachable end caps.

### 2. DESCRIPTION OF THE PRIOR ART

Currently available emergency lighting devices typically use fluorescent tubes or incandescent lamps as light sources, which suffer from various issues such as short service life and high energy consumption. Light-emitting diodes (LEDs) offer numerous advantages, including high efficiency, energy savings, and long service life. With the rapid development of LED technology, LED lighting devices have gradually become the primary light source for lighting systems.

However, most LED emergency lighting devices require the installation of rechargeable batteries. When the rechargeable battery is damaged, users are unable to replace the faulty battery and can only either replace the entire emergency lighting device or send the damaged device for repair. This significantly increases the maintenance costs of the lighting system. As a result, the currently available LED emergency lighting devices no longer meet actual requirements.

### SUMMARY OF THE INVENTION

One embodiment of the present invention provides an emergency lighting device with detachable end caps, which includes a tube body, two end caps, an input circuit and a load. The end caps are respectively disposed at two ends of the tube body. Each of the end caps includes a cylindrical body connected to the tube body and a cover detachably mounted on the cylindrical body. The input circuit has a first pin, a second pin, a third pin, and a fourth pin. The first pin, the second pin, the third pin, and the fourth pin are respectively disposed on the two end caps and connected to an external power source. The load is disposed inside the tube body and connected to the input circuit.

In one embodiment, the input circuit is disposed inside the tube body or inside one of the end caps.

In one embodiment, the emergency lighting device further includes a processing circuit and an emergency circuit. The processing circuit is connected to the input circuit. The emergency circuit is disposed inside one of the end caps and connected to the processing circuit and the load.

In one embodiment, the emergency circuit includes a rechargeable battery detachably disposed inside the cylindrical body.

In one embodiment, the emergency lighting device further includes a color temperature adjustment switch connected to the processing circuit.

In one embodiment, the emergency lighting device further includes a mode control switch and a mode control circuit. The mode control switch is disposed on one of the end caps and connected to the mode control circuit. The mode control circuit is disposed inside the tube body or inside one of the end caps and connected to the processing circuit.

In one embodiment, the mode control switch is T-shaped.

In one embodiment, the emergency lighting device further includes a warning light disposed on one of the end caps and located below the mode control switch. The warning light being connected to the mode control circuit.

In one embodiment, one of the end caps has a light-transmitting groove surrounding the mode control switch.

In one embodiment, the load is a light source board, a light-emitting diode, or a light-emitting diode array.

The emergency lighting device with detachable end caps in accordance with the embodiments of the present invention may have the following advantages:
(1) In one embodiment of the present invention, the emergency lighting device includes a tube body, two end caps, an input circuit and a load. The end caps are respectively disposed at two ends of the tube body. Each of the end caps includes a cylindrical body connected to the tube body and a cover detachably mounted on the cylindrical body. The input circuit has a first pin, a second pin, a third pin, and a fourth pin. The first pin, the second pin, the third pin, and the fourth pin are respectively disposed on the two end caps and connected to an external power source. The load is disposed inside the tube body and connected to the input circuit. Through the structural design of the detachable end caps, the user can conveniently maintain the emergency lighting device. Therefore, the maintenance of the emergency lighting device can be more convenient.
(2) In one embodiment of the present invention, the emergency lighting device further includes a processing circuit and an emergency circuit. The processing circuit is connected to the input circuit. The emergency circuit is disposed inside one of the end caps, and connected to the processing circuit and the load. The emergency circuit includes a rechargeable battery, and the rechargeable battery is detachably disposed inside the cylindrical body. Through the integrated structure of the detachable end cap and the rechargeable battery, the user can directly remove the cover of the end cap and replace the rechargeable battery when the rechargeable battery is damaged, such that the emergency lighting device can function normally. Thus, the user can quickly replace a damaged rechargeable battery with a new one without discarding the emergency lighting device. Therefore, the emergency lighting device can significantly reduce the maintenance costs of the lighting system and meet actual requirements.
(3) In one embodiment of the present invention, the emergency lighting device further includes a color temperature adjustment switch. The color temperature adjustment switch is connected to the processing circuit. The color temperature adjustment switch provides a color temperature adjustment function, such that the user can adjust the color temperature of the emergency lighting device by operating the switch to achieve the desired lighting effect. Therefore, the emergency lighting device can offer a wider range of color temperatures, so the emergency lighting device can be more comprehensive in application and flexible in use.
(4) In one embodiment of the present invention, the load of the emergency lighting device may be a light source board, which includes a circuit board and a plurality of light sources. The circuit board may be a flexible circuit board, and the tube body may be a glass tube. The combination of the flexible circuit board and the glass tube can significantly reduce the difficulty of the manufacturing process for the emergency lighting device, thereby reducing labor costs. Therefore, the manufacturing cost of the emergency lighting device can be lowered.
(5) In one embodiment of the present invention, the emergency lighting device further includes a mode control switch, a mode control circuit, and a warning light. The mode control switch is disposed on one of the end caps and connected to the mode control circuit. The mode control circuit is disposed inside the tube body or one of the end caps and connected to the processing circuit. The warning light is disposed on one of the end caps and located below the mode control switch. The warning light is connected to the mode control circuit. The end cap has a light-transmitting groove, and the light-transmitting groove surrounds the mode control switch. This integrated design allows the light emitted by the warning light to directly pass through the light-transmitting groove and increases the light-emitting area of the warning light. Therefore, the user can quickly identify the status of the emergency lighting device based on the light emitted by the warning light.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic view of an emergency lighting device with detachable end caps in accordance with a first embodiment of the present invention.

FIG. 2 is a block diagram of a circuit structure of the emergency lighting device with detachable end caps in accordance with the first embodiment of the present invention.

FIG. 3 is a block diagram of a circuit structure of an emergency lighting device with detachable end caps in accordance with a second embodiment of the present invention.

FIG. 4 is a schematic view of an emergency lighting device with detachable end caps in accordance with a third embodiment of the present invention.

FIG. 5 is another schematic view of the emergency lighting device with detachable end caps in accordance with the third embodiment of the present invention.

FIG. 6 is a block diagram of a circuit structure of the emergency lighting device with detachable end caps in accordance with the third embodiment of the present invention.

FIG. 7 is a schematic view of an emergency lighting device with detachable end caps in accordance with a fourth embodiment of the present invention.

FIG. 8 is a side view of an emergency lighting device with detachable end caps in accordance with a fifth embodiment of the present invention.

FIG. 9 is a first partial enlargement view of an emergency lighting device with detachable end caps in accordance with a fifth embodiment of the present invention.

FIG. 10 is a second partial enlargement view of the emergency lighting device with detachable end caps in accordance with the fifth embodiment of the present invention.

FIG. 11 is a third partial enlargement view of the emergency lighting device with detachable end caps in accordance with the fifth embodiment of the present invention.

FIG. 12 is a fourth partial enlargement view of the emergency lighting device with detachable end caps in accordance with the fifth embodiment of the present invention.

FIG. 13 is a schematic view of a load of the emergency lighting device with detachable end caps in accordance with the fifth embodiment of the present invention.

FIG. 14 is a schematic view of an inner structure of one of the end caps of the emergency lighting device with detachable end caps in accordance with the fifth embodiment of the present invention.

FIG. 15 is an exploded view of an emergency lighting device with detachable end caps in accordance with the sixth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

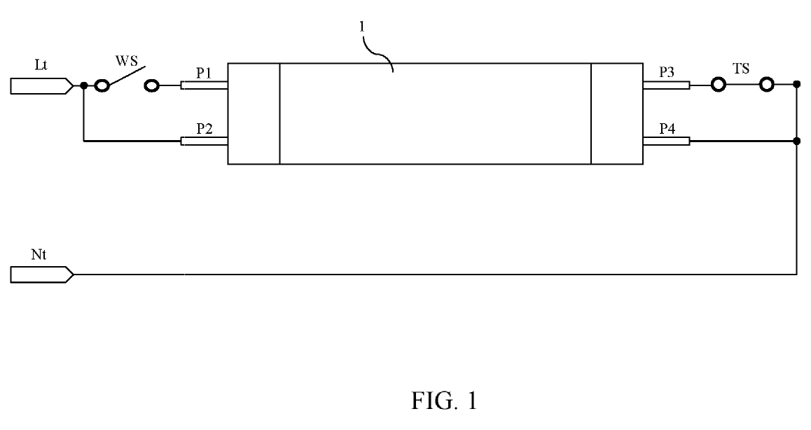

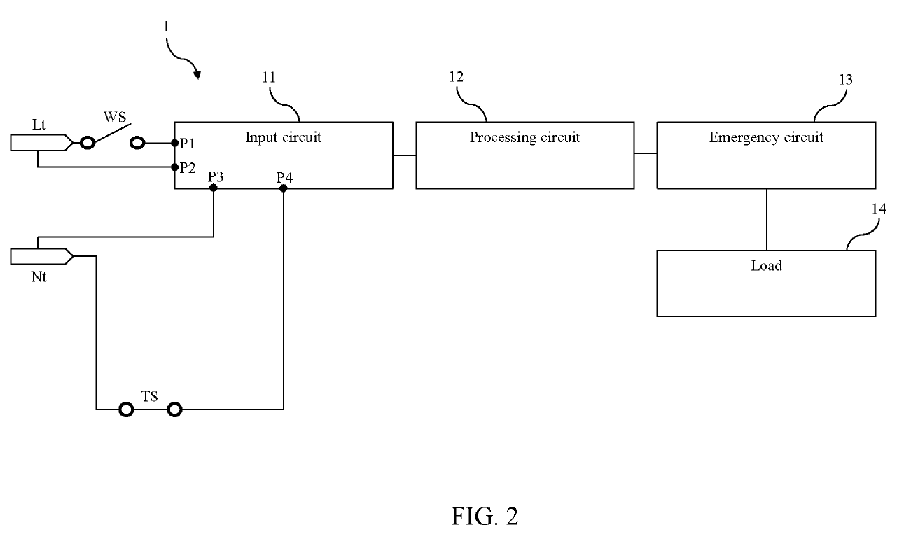

Please refer to FIG. 1 and FIG. 2. FIG. 1 is a schematic view of an emergency lighting device with detachable end caps in accordance with a first embodiment of the present invention. FIG. 2 is a block diagram of a circuit structure of the emergency lighting device with detachable end caps in accordance with the first embodiment of the present invention. As shown in FIG. 1 and FIG. 2, the emergency lighting device 1 includes an emergency test switch TS, an input circuit 11, a processing circuit 12, an emergency circuit 13, and a load 14.

The input circuit 11 has a first pin P1, a second pin P2, a third pin P3, and a fourth pin P4. The first pin P1 is connected to the live wire output terminal Lt of an external power source via a main switch WS. The second pin P2 is connected to the live wire output terminal Lt. The third pin P3 is connected to the neutral wire output terminal Nt of the external power source via the emergency test switch TS. The fourth pin P4 is connected to the neutral wire output terminal Nt. In one embodiment, the input circuit 11 includes one or more of a rectifier circuit, a filter circuit, an overcurrent protection circuit, a surge protection circuit, and an electromagnetic interference (EMI) circuit. The circuit structure of the input circuit 11 is well-known to those skilled in the art and will not be described in detail here. In one embodiment, the main switch WS may be a wall switch, an external control switch, or any currently available switch component. In one embodiment, the external power source may be utility power, a generator, or other similar components. In one embodiment, the emergency test switch TS may be an external normally closed switch. In another embodiment, the emergency test switch TS may also be a built-in switch.

The processing circuit 12 is connected to the input circuit 11. In one embodiment, the processing circuit 12 may be a microcontroller (MCU), a central processing unit (CPU), an application-specific integrated circuit (ASIC), a field-programmable gate array (FPGA), or other similar components. The circuit structure of the processing circuit 12 is well-known to those skilled in the art and will not be described in detail here.

The emergency circuit 13 includes a rechargeable battery and a charging control circuit. The charging control circuit can control the charging and discharging of the rechargeable battery, and the circuit structure thereof is well-known to those skilled in the art and will not be described in detail here.

The load 14 is connected to the emergency circuit 13. In one embodiment, the load 14 may be a light source board. In another embodiment, the load 14 may also be a light-emitting diode (LED) or an LED array.

The processing circuit 12 receives an emergency test signal when the emergency test switch TS is operated in a preset operation mode and executes an emergency test mode to control the emergency circuit 13 to activate the load 14. The preset operation mode is that the emergency test switch TS remains in off state for a preset time.

For example, the preset time may be 10 seconds. The user can operate the emergency test switch TS to remain in the off state for 10 seconds. At this time, since the emergency test switch TS is in off state, the processing circuit 12 detects that the level state of the third pin P3 indicates that the third pin P3 is not connected to the external power source and this state is maintained for 10 seconds. Then, the processing circuit 12 can execute the emergency test mode. In the emergency test mode, the processing circuit 12 controls the emergency circuit 13 to activate the load 14 to perform the emergency function. The preset time may be 5 seconds, 7 seconds, etc., and can be adjusted according to actual needs.

In this way, the user can quickly and efficiently perform the emergency test function to confirm whether the processing circuit 12 can normally control the emergency circuit 13 to activate the load 14. The user can take necessary measures in time when the emergency function is abnormal.

Via the design of the emergency test switch TS, the processing circuit 12 can quickly and effectively execute the emergency test mode to test whether the emergency function is normal. Therefore, the reliability of the emergency lighting device 1 can be significantly improved.

In addition, the processing circuit 12 can directly determine whether to activate the emergency test function based on the level state of the third pin P3 (whether the third pin P3 is connected to the external power source). Therefore, regardless of whether the main switch WS is in on state or off state, the processing circuit 12 can quickly and effectively execute the emergency test mode. Therefore, the maintenance of the emergency lighting device 1 can be more convenient to meet actual requirements.

The embodiment just exemplifies the present invention and is not intended to limit the scope of the present invention; any equivalent modification and variation according to the spirit of the present invention is to be also included within the scope of the following claims and their equivalents.

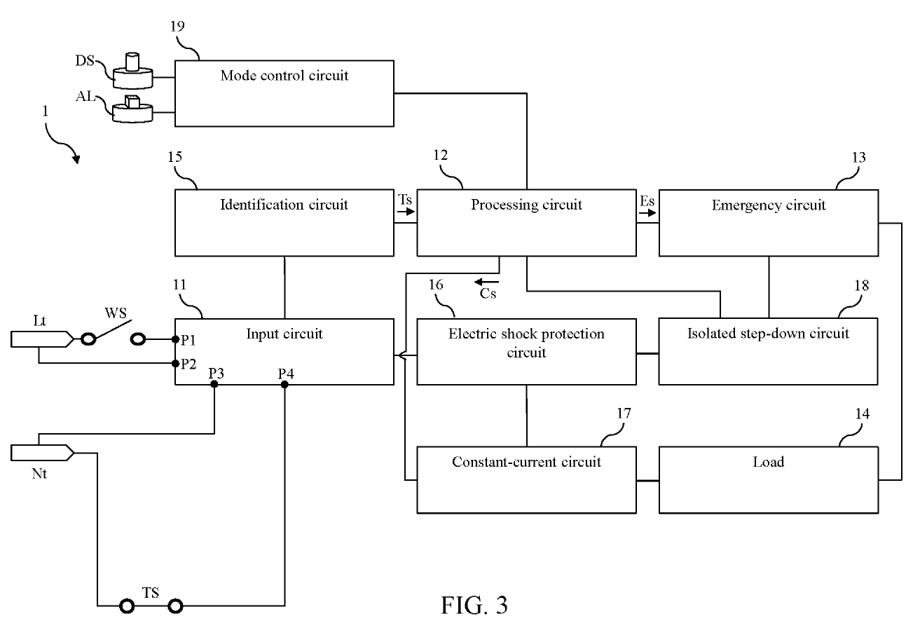

Please refer to FIG. 3, which is a block diagram of a circuit structure of an emergency lighting device with detachable end caps in accordance with a second embodiment of the present invention., and also refer to FIG. 1. This embodiment illustrates the complete circuit structure of the emergency lighting device 1. As shown in FIG. 3, the emergency lighting device 1 includes an emergency test switch TS, an input circuit 11, an identification circuit 15, a processing circuit 12, an emergency circuit 13, a load 14, an electric shock protection circuit 16, a constant-current circuit 17, an isolated step-down circuit 18, a mode control circuit 19, a mode control switch DS, and a warning light AL.

The input circuit 11 has a first pin P1, a second pin P2, a third pin P3, and a fourth pin P4. The first pin P1 is connected to the live wire output terminal Lt of the external power source via the main switch WS. The second pin P2 is connected to the live wire output terminal Lt. The third pin P3 is connected to the neutral wire output terminal Nt of the external power source through the emergency test switch TS. The fourth pin P4 is connected to the neutral wire output terminal Nt.

The processing circuit 12 is connected to the input circuit 11 via the identification circuit 15 and is connected to the mode control circuit 19, the emergency circuit 13, and the isolated step-down circuit 18. In addition, the processing circuit 12 is also connected to the constant-current circuit 17 via an opto-isolation component (such as an optocoupler). The opto-isolation component can provide good isolation, and the processing circuit 12 can still transmit signals to the constant-current circuit 17 to control the constant-current circuit 17. In one embodiment, the mode control circuit 19 may be a microcontroller (MCU), a central processing unit (CPU), an application-specific integrated circuit (ASIC), a field-programmable gate array (FPGA), or other similar components. The circuit structure of the mode control circuit 19 is well-known to those skilled in the art and will not be described in detail here. In one embodiment, the isolated step-down circuit 18 may be an isolation transformer or other components with similar functions. The circuit structure of the isolated step-down circuit 18 is well-known to those skilled in the art and will not be described in detail here. In one embodiment, the identification circuit 15 may be a circuit capable of identifying high and low level signals, and the circuit structure thereof is well-known to those skilled in the art and will not be described in detail here.

The electric shock protection circuit 16 is connected to the input circuit 11 and is connected to the isolated step-down circuit 18 and the constant-current circuit 17. The constant-current circuit 17 is connected to the load 14. In one embodiment, the electric shock protection circuit 16 may be a circuit with leakage protection functionality, and the circuit structure thereof is well-known to those skilled in the art and will not be described in detail here. In one embodiment, the constant-current circuit 17 may be a buck converter, a boost converter, a buck-boost converter, or other similar components.

When the external power source is operating normally and the main switch WS is on, the input circuit 11 drives the load 14 to perform the normal lighting mode. When the external power source is operating normally and the main switch WS is on, the identification circuit 15 determines that the input circuit 11 is connected to the external power source. At this time, the input circuit 11 drives the constant-current circuit 17, causing the constant-current circuit 17 to drive the load 14 to perform the normal lighting mode. At the same time, the input circuit 11 supplies power to the emergency circuit 13 via the isolated step-down circuit 18, and the processing circuit 12 controls the emergency circuit 13 to enter the charging state.

The processing circuit 12 receives the emergency test signal Ts from the identification circuit 15 when the emergency test switch TS is operated in the preset operation mode. At this time, if the emergency lighting device 1 is in the normal lighting mode, the processing circuit 12 transmits an operating signal Cs to the constant-current circuit 17 to turn off the constant-current circuit 17. At the same time, the processing circuit 12 transmits a test control signal Es to the emergency circuit 13 to execute the emergency test mode and control the emergency circuit 13 to activate the load 14.

When the external power source is abnormal, the identification circuit 15 determines that the input circuit 11 is not connected to the external power source. At this time, the processing circuit 12 controls the emergency circuit 13 to drive the load 14 to perform the emergency lighting mode.

The mode control switch DS is connected to the mode control circuit 19. The mode control switch DS is used to control the mode control circuit 19 to generate a mode control signal to control the processing circuit 12 to enter the transport mode. The processing circuit 12 enters a sleep state in the transport mode and turns off other circuits to reduce power consumption.

In addition, the warning light AL is connected to the mode control circuit 19. The mode control circuit 19 can generate a status signal and transmit the status signal to the warning light AL, causing the warning light AL to display the status corresponding to the status signal in different warning modes. For example, fault status, charging status, transport mode, emergency lighting mode, normal lighting mode, etc. Therefore, the functions of the emergency lighting device 1 can be more complete to meet different application needs.

As set forth above, the emergency lighting device 1 integrates both normal lighting and emergency lighting functions. The main switch WS is used to control the normal lighting mode. When the external power source (utility power) is abnormal (power outage), the processing circuit 12 executes the emergency lighting mode. When the emergency test switch TS is triggered, the emergency test mode is performed regardless of whether the main switch WS is closed. In this way, the user can conveniently check whether the functions of the emergency lighting device 1 are normal and whether maintenance is required.

The embodiment just exemplifies the present invention and is not intended to limit the scope of the present invention; any equivalent modification and variation according to the spirit of the present invention is to be also included within the scope of the following claims and their equivalents.

It is worthy to point out that most LED emergency lighting devices require the installation of rechargeable batteries. When the rechargeable battery is damaged, users are unable to replace the faulty battery and can only either replace the entire emergency lighting device or send the damaged device for repair. This significantly increases the maintenance costs of the lighting system. As a result, the currently available LED emergency lighting devices no longer meet actual requirements. By contrast, according to one embodiment of the present invention, the emergency lighting device includes a tube body, two end caps, an input circuit and a load. The end caps are respectively disposed at two ends of the tube body. Each of the end caps includes a cylindrical body connected to the tube body and a cover detachably mounted on the cylindrical body. The input circuit has a first pin, a second pin, a third pin, and a fourth pin. The first pin, the second pin, the third pin, and the fourth pin are respectively disposed on the two end caps and connected to an external power source. The load is disposed inside the tube body and connected to the input circuit. Through the structural design of the detachable end caps, the user can conveniently maintain the emergency lighting device. Therefore, the maintenance of the emergency lighting device can be more convenient.

Also, according to one embodiment of the present invention, the emergency lighting device further includes a processing circuit and an emergency circuit. The processing circuit is connected to the input circuit. The emergency circuit is disposed inside one of the end caps, and connected to the processing circuit and the load. The emergency circuit includes a rechargeable battery, and the rechargeable battery is detachably disposed inside the cylindrical body. Through the integrated structure of the detachable end cap and the rechargeable battery, the user can directly remove the cover of the end cap and replace the rechargeable battery when the rechargeable battery is damaged, such that the emergency lighting device can function normally. Thus, the user can quickly replace a damaged rechargeable battery with a new one without discarding the emergency lighting device. Therefore, the emergency lighting device can significantly reduce the maintenance costs of the lighting system and meet actual requirements.

Further, according to one embodiment of the present invention, the emergency lighting device further includes a color temperature adjustment switch. The color temperature adjustment switch is connected to the processing circuit. The color temperature adjustment switch provides a color temperature adjustment function, such that the user can adjust the color temperature of the emergency lighting device by operating the switch to achieve the desired lighting effect. Therefore, the emergency lighting device can offer a wider range of color temperatures, so the emergency lighting device can be more comprehensive in application and flexible in use.

Moreover, according to one embodiment of the present invention, the load of the emergency lighting device may be a light source board, which includes a circuit board and a plurality of light sources. The circuit board may be a flexible circuit board, and the tube body may be a glass tube. The combination of the flexible circuit board and the glass tube can significantly reduce the difficulty of the manufacturing process for the emergency lighting device, thereby reducing labor costs. Therefore, the manufacturing cost of the emergency lighting device can be lowered.

Furthermore, according to one embodiment of the present invention, the emergency lighting device further includes a mode control switch, a mode control circuit, and a warning light. The mode control switch is disposed on one of the end caps and connected to the mode control circuit. The mode control circuit is disposed inside the tube body or one of the end caps and connected to the processing circuit. The warning light is disposed on one of the end caps and located below the mode control switch. The warning light is connected to the mode control circuit. The end cap has a light-transmitting groove, and the light-transmitting groove surrounds the mode control switch. This integrated design allows the light emitted by the warning light to directly pass through the light-transmitting groove and increases the light-emitting area of the warning light. Therefore, the user can quickly identify the status of the emergency lighting device based on the light emitted by the warning light. As described above, the emergency lighting device with detachable end caps according to the embodiments of the present invention can achieve great technical effects.

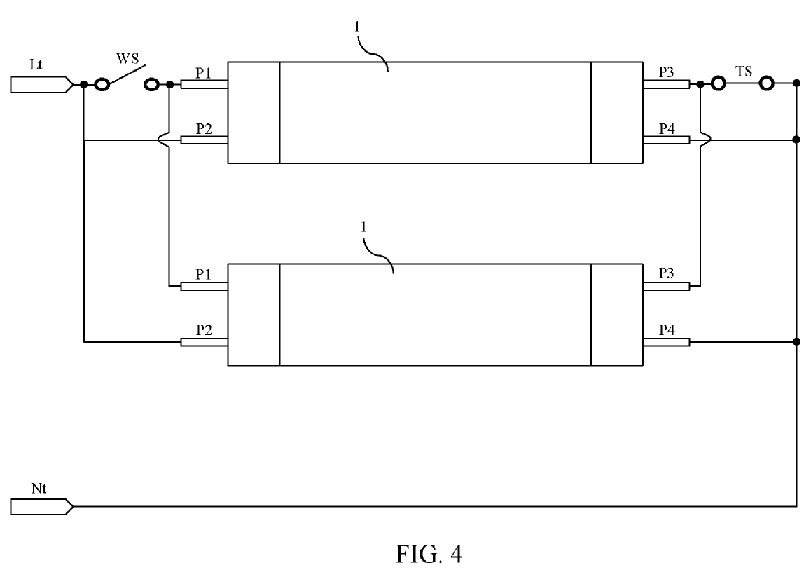

Please refer to FIG. 4, which is a schematic view of an emergency lighting device with detachable end caps in accordance with a third embodiment of the present invention, and also refer to FIG. 2. As shown FIG. 4, the circuit structure of the emergency lighting device 1 is the same as that of the previous embodiments, so it will not be described in detail here.

The difference between this embodiment and the previous embodiments is that several emergency lighting devices 1 (only two emergency lighting devices 1 are shown in FIG. 4) share one emergency test switch TS. The connection relationship between the emergency test switch TS and the input circuit 11 of each emergency lighting device 1 is the same as that in the first and second embodiments, so it will not be described in detail here.

The embodiment just exemplifies the present invention and is not intended to limit the scope of the present invention; any equivalent modification and variation according to the spirit of the present invention is to be also included within the scope of the following claims and their equivalents.

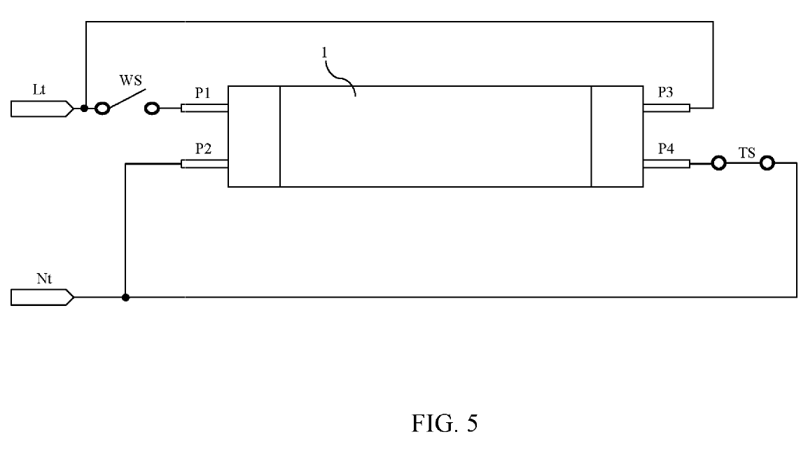

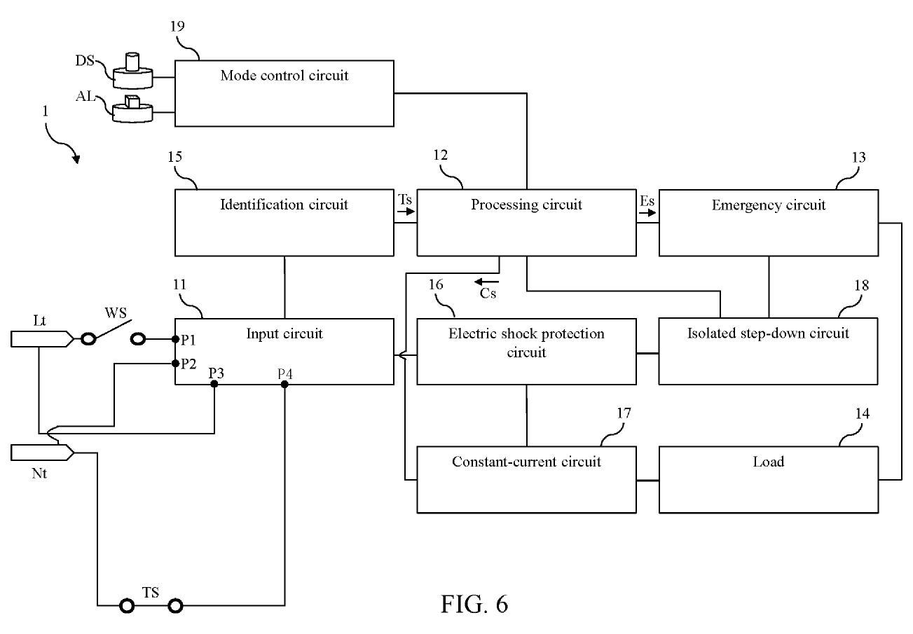

Please refer to FIG. 5 and FIG. 6. FIG. 5 is another schematic view of the emergency lighting device with detachable end caps in accordance with the third embodiment of the present invention. FIG. 6 is a block diagram of a circuit structure of the emergency lighting device with detachable end caps in accordance with the third embodiment of the present invention. As shown in FIG. 5 and FIG. 6, the emergency lighting device 1 includes an emergency test switch TS, an input circuit 11, an identification circuit 15, a processing circuit 12, an emergency circuit 13, a load 14, an electric shock protection circuit 16, a constant-current circuit 17, an isolated step-down circuit 18, a mode control circuit 19, a mode control switch DS, and a warning light AL. The above components are the same as those in the second embodiment, so they will not be described in detail here.

The difference between this embodiment and the previous embodiments is that the connection relationship of the input circuit 11 of the emergency lighting device 1 is different. The first pin P1 is connected to the live wire output terminal Lt of the external power source via the main switch WS. The second pin P2 is connected to the neutral wire output terminal Nt of the external power source. The third pin P3 is connected to the live wire output terminal Lt. The fourth pin P4 is connected to the neutral wire output terminal Nt via the emergency test switch TS.

Similarly, the processing circuit 12 receives the emergency test signal Ts from the identification circuit 15 when the emergency test switch TS is operated in the preset operation mode. At this time, if the emergency lighting device 1 is in the normal lighting mode, the processing circuit 12 transmits a control signal Cs to the constant-current circuit 17 to turn off the constant-current circuit 17. At the same time, the processing circuit 12 transmits a test control signal Es to the emergency circuit 13 to execute the emergency test mode and control the emergency circuit 13 to activate the load 14.

Via the design of the emergency test switch TS, the processing circuit 12 can quickly and effectively execute the emergency test mode to test whether the emergency function is normal. Therefore, the reliability of the emergency lighting device 1 can be significantly improved.

In addition, the processing circuit 12 can directly determine whether to activate the emergency test function based on the level state of the fourth pin P4 (whether the fourth pin P4 is connected to the external power source). Therefore, regardless of whether the main switch WS is in on state or off state, the processing circuit 12 can quickly and effectively execute the emergency test mode. Therefore, the maintenance of the emergency lighting device 1 can be more convenient to meet actual requirements.

The embodiment just exemplifies the present invention and is not intended to limit the scope of the present invention; any equivalent modification and variation according to the spirit of the present invention is to be also included within the scope of the following claims and their equivalents.

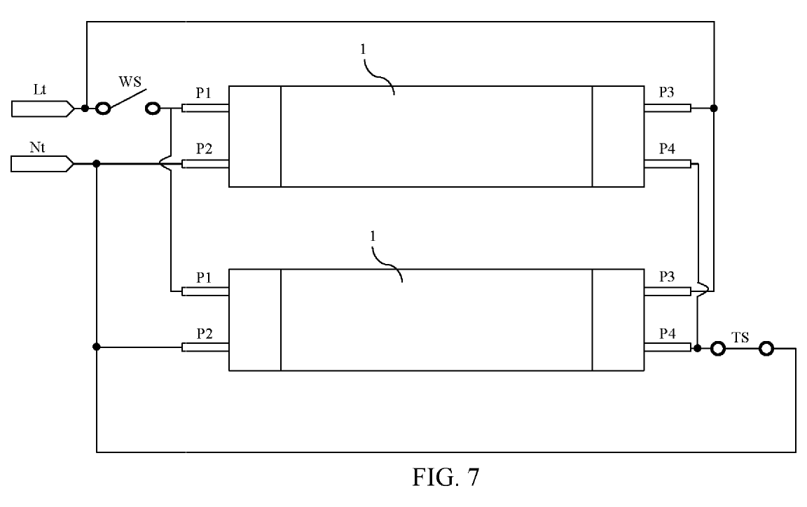

Please refer to FIG. 7, which is a schematic view of an emergency lighting device with detachable end caps in accordance with a fourth embodiment of the present invention, and also refer to FIG. 6. As shown in FIG. 7, the circuit structure of the emergency lighting device 1 is the same as that of the previous embodiments, so it will not be described in detail here.

The difference between this embodiment and the previous embodiments is that several emergency lighting devices 1 (only two emergency lighting devices 1 are shown in FIG. 7) share one emergency test switch TS. The connection relationship between the emergency test switch TS and the input circuit 11 of each emergency lighting device 1 is the same as that in the third embodiment, so it will not be described in detail here.

The embodiment just exemplifies the present invention and is not intended to limit the scope of the present invention; any equivalent modification and variation according to the spirit of the present invention is to be also included within the scope of the following claims and their equivalents.

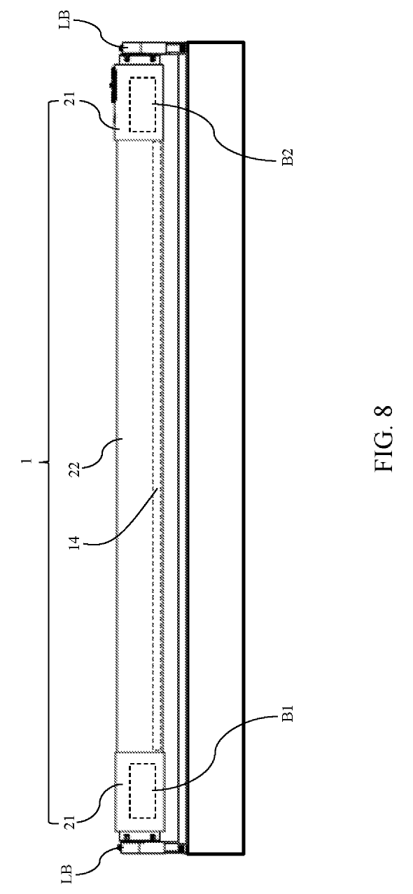

Please refer to FIG. 8, which is a side view of an emergency lighting device with detachable end caps in accordance with a fifth embodiment of the present invention, and also refer to FIG. 5 and FIG. 6. As shown in FIG. 8, the emergency lighting device 1 further includes two end caps 21 and a tube body 22. The two end caps 21 are respectively disposed at both ends of the tube body 22. The input circuit 11, the identification circuit 15, the processing circuit 12, the emergency circuit 13, the load 14, the electric shock protection circuit 16, the constant-current circuit 17, the isolated step-down circuit 18, and the mode control circuit 19 can all be disposed inside the tube body 22. In another embodiment, the input circuit 11, the identification circuit 15, the processing circuit 12, the emergency circuit 13, the load 14, the electric shock protection circuit 16, the constant-current circuit 17, the isolated step-down circuit 18, and the mode control circuit 19 can all be disposed inside one of the end caps 21, as shown in the area B1 of FIG. 8. In addition, a battery can be disposed inside the other one of the end caps 21, as shown in the area B2 of FIG. 8. The emergency lighting device 1 can be installed on a lamp base LB to connect to an external power source (such as utility power). As mentioned earlier, the emergency test switch TS may be an external normally closed switch, which can be installed on one of the end caps 21. Moreover, the tube body 22 can be wrapped with PET film.

The size of the end cap 21 is reduced, allowing the tube body 22 of the emergency lighting device 1 to be extended. Therefore, the light efficiency of the emergency lighting device 1 can be significantly improved.

The embodiment just exemplifies the present invention and is not intended to limit the scope of the present invention; any equivalent modification and variation according to the spirit of the present invention is to be also included within the scope of the following claims and their equivalents.

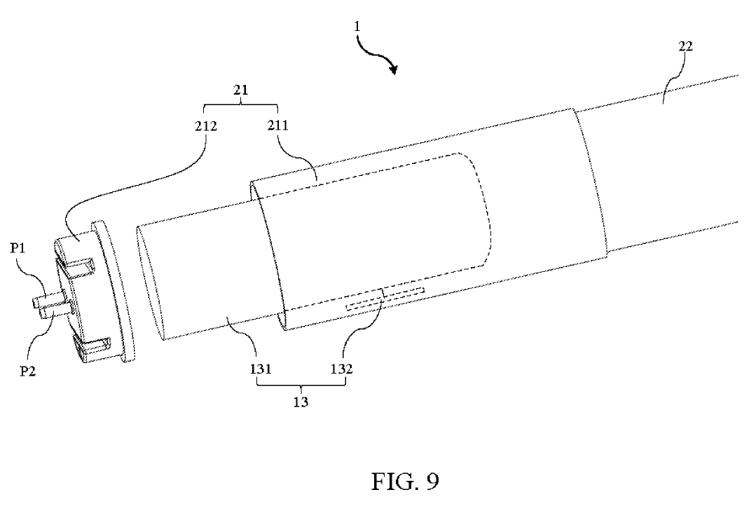

Please refer to FIG. 9, which is a first partial enlargement view of an emergency lighting device with detachable end caps in accordance with a fifth embodiment of the present invention, and also refer to FIG. 5 and FIG. 6. As shown in FIG. 9, each end cap 21 includes a cylindrical body 211 and a cover 212. The cover 212 is detachably mounted on the cylindrical body 211.

The first pin P1 and the second pin P2 of the input circuit 11 are disposed on one of the end caps 21. As mentioned earlier, the emergency circuit 13 includes a rechargeable battery 131 and a charging control circuit 132. The rechargeable battery 131 is detachably disposed inside the cylindrical body 211.

In this way, when the rechargeable battery 131 is damaged, the user can directly remove the cover 212 of the end cap 21 and replace the rechargeable battery 131, allowing the emergency lighting device to function normally.

Through the structural design of the detachable end cap 21, the user can conveniently maintain the emergency lighting device 1. Therefore, the maintenance of the emergency lighting device 1 can be more convenient.

In addition, via the integrated structure of the detachable end cap 21 and the rechargeable battery 131, the user can directly remove the cover 212 of the end cap 21 and replace the rechargeable battery 131 when the rechargeable battery 131 is damaged, allowing the emergency lighting device 1 to function normally. In this way, the user can quickly replace a damaged rechargeable battery 131 with a new one without discarding the emergency lighting device 1. Therefore, the emergency lighting device 1 can significantly reduce the maintenance costs of the lighting system and better meet actual requirements.

The embodiment just exemplifies the present invention and is not intended to limit the scope of the present invention; any equivalent modification and variation according to the spirit of the present invention is to be also included within the scope of the following claims and their equivalents.

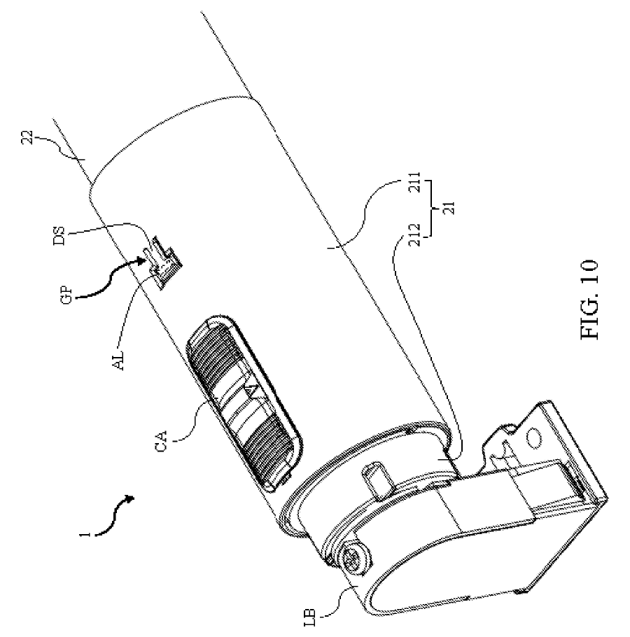

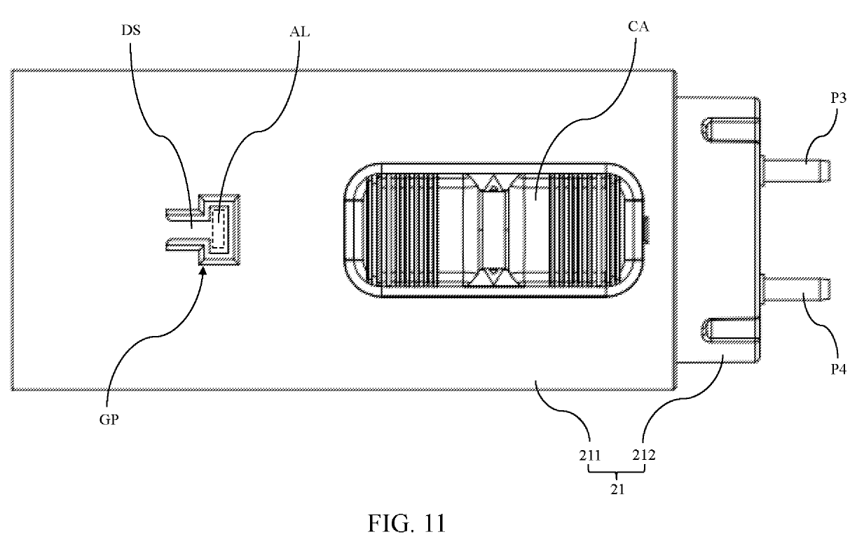

Please refer to FIG. 10 and FIG. 11. FIG. 10 is a second partial enlargement view of the emergency lighting device with detachable end caps in accordance with the fifth embodiment of the present invention. FIG. 11 is a third partial enlargement view of the emergency lighting device with detachable end caps in accordance with the fifth embodiment of the present invention. Please also refer to FIG. 5 and FIG. 6. As shown in FIG. 10 and FIG. 11, the third pin P3 and the fourth pin P4 of the input circuit 11 are disposed on the other end cap 21. The mode control switch DS and the warning light AL can be disposed on this end cap 21, and this end cap 21 may also include a color temperature adjustment switch CA, which is connected to the processing circuit 12.

The mode control switch DS is surrounded by a light-transmitting groove GP, and the warning light AL is disposed below the mode control switch DS. In this embodiment, the mode control switch DS is T-shaped, and the light-transmitting groove GP surrounds the mode control switch DS. This integrated design allows the light emitted by the warning light AL to directly pass through the light-transmitting groove GP, and increases the light-emitting area of the warning light AL. Therefore, the user can quickly identify the status of the emergency lighting device 1 according to the light emitted by the warning light AL.

Additionally, the user can adjust the color temperature of the emergency lighting device 1 by operating the color temperature adjustment switch CA to achieve the desired lighting effect. Thus, the emergency lighting device 1 can provide a wider range of color temperatures, such that the emergency lighting device 1 can be more comprehensive in application and flexible in use.

The embodiment just exemplifies the present invention and is not intended to limit the scope of the present invention; any equivalent modification and variation according to the spirit of the present invention is to be also included within the scope of the following claims and their equivalents.

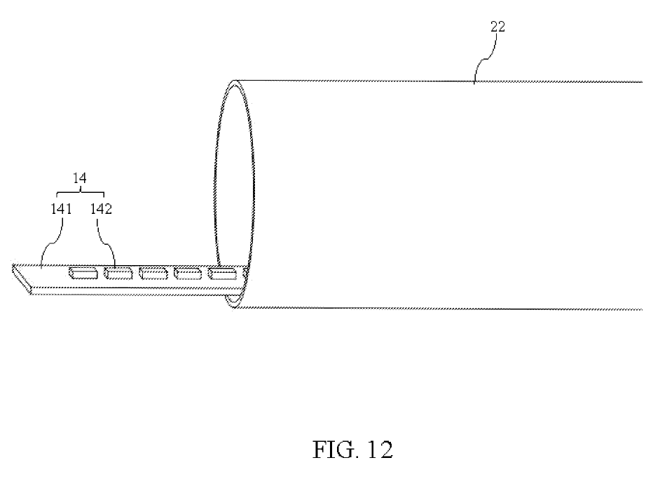

Please refer to FIG. 12, which is a fourth partial enlargement view of the emergency lighting device with detachable end caps in accordance with the fifth embodiment of the present invention, and also refer to FIG. 5 and FIG. 6. As shown FIG. 12, the load 14 can be disposed inside the tube body 22. The load 14 can be a light source board, which includes a circuit board 141 and a plurality of light sources 142 (only a portion of the light sources 142 are shown in the figure, and the number of light sources 142 can be adjusted according to actual needs). The light sources 142 can be light-emitting diodes. In this embodiment, the circuit board 141 can be a flexible circuit board, and the tube body 22 can be a glass tube. The combination of a flexible circuit board and a glass tube can significantly reduce the difficulty of the manufacturing process of the emergency lighting device 1, thereby reducing labor costs. Therefore, the manufacturing cost of the emergency lighting device 1 can be lowered.

In another embodiment, the circuit board 141 can be a rigid circuit board or a rigid-flex board, and the tube body 22 can be made of other transparent or semi-transparent materials, such as various plastic materials.

The embodiment just exemplifies the present invention and is not intended to limit the scope of the present invention; any equivalent modification and variation according to the spirit of the present invention is to be also included within the scope of the following claims and their equivalents.

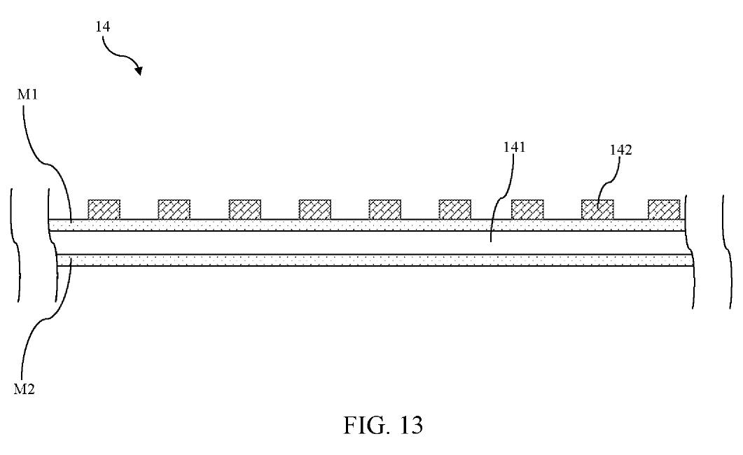

Please refer to FIG. 13, which is a schematic view of a load of the emergency lighting device with detachable end caps in accordance with the fifth embodiment of the present invention. As shown in FIG. 13, the load 14 (light source board) can include a circuit board 141 and a plurality of light sources 142. The circuit board 141 can be a flexible circuit board. The upper surface of the circuit board 141 is provided with an upper metal layer M1, and the lower surface of the circuit board 141 is provided with a lower metal layer M2. The light sources 142 are disposed on the upper metal layer M1. The upper metal layer M1 and the lower metal layer M2 can be made of copper or other metal materials (such as gold, silver, etc.).

The upper metal layer M1 and the lower metal layer M2 can be formed on the upper and lower surfaces of the circuit board 141 through methods such as electroplating.

The upper metal layer M1 and the lower metal layer M2 have thermal conductivity functions, so the circuit board 141 with double-sided metal coating can achieve better heat dissipation, extending the service life of the load 14. Additionally, the upper metal layer M1 and the lower metal layer M2 can also increase the hardness of the circuit board 141, allowing the circuit board 141 with double-sided metal coating to achieve higher structural strength. Therefore, the circuit board 141 can be stably disposed inside the tube body 22 without being prone to bending.

The embodiment just exemplifies the present invention and is not intended to limit the scope of the present invention; any equivalent modification and variation according to the spirit of the present invention is to be also included within the scope of the following claims and their equivalents.

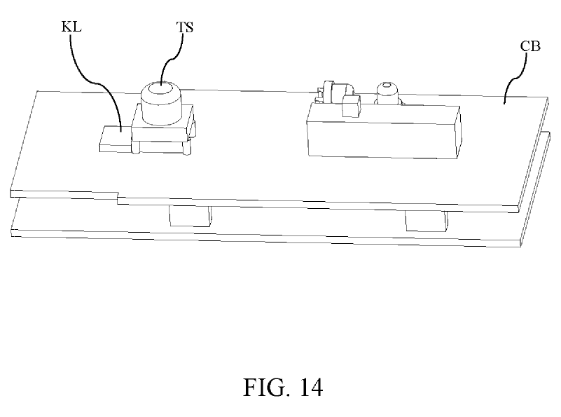

Please refer to FIG. 14, which is a schematic view of an inner structure of one of the end caps of the emergency lighting device with detachable end caps in accordance with the fifth embodiment of the present invention. As shown in FIG. 14, the emergency test switch TS can also be disposed in one of the end caps 21. The emergency lighting device 1 may further include an emergency test light KL. The emergency test switch TS and the emergency test light KL can be disposed on the circuit board CB within this end cap 21. When the emergency test switch TS is triggered, the processing circuit 12 executes the emergency lighting mode. Simultaneously, the emergency test light KL emits light to indicate that the processing circuit 12 is executing the emergency lighting mode.

The embodiment just exemplifies the present invention and is not intended to limit the scope of the present invention; any equivalent modification and variation according to the spirit of the present invention is to be also included within the scope of the following claims and their equivalents.

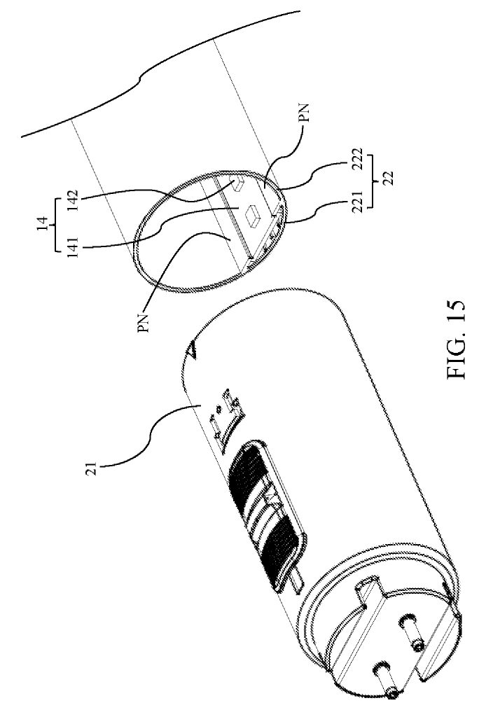

Please refer to FIG. 15, which is an exploded view of an emergency lighting device in accordance with the sixth embodiment of the present invention. As shown in FIG. 15, the emergency lighting device 1 includes two end caps 21 and a tube body 22. The two end caps 21 are respectively disposed at both ends of the tube body 22 (only one end cap 21 is shown in the figure). A load 14 may be disposed inside the tube body 22. The load 14 may be a light source board, which includes a circuit board 141 and a plurality of light sources 142 (only a portion of the light sources 142 is shown in the figure; the number of light sources 142 can be adjusted according to actual needs).

The difference between this embodiment and the previous embodiments is that both sides of the circuit board 141 may be covered with metal layers such as copper layers, which can effectively enhance the structural strength of the circuit board 141 and improve heat dissipation performance.

Additionally, in contrast to the previous embodiments, the tube body 22 includes a first tube body portion 221 and a second tube body portion 222 that are connected to each other. The first tube body portion 221 is made of an opaque light-blocking material such as plastic or metal. Furthermore, the first tube body portion 221 is provided with two fixing plates PN, which are respectively disposed on both sides of the first tube body portion 221 and are used to secure the load 14 (light source board), so that the load 14 can be fixed inside the first tube body portion 221. The first tube body portion 221 can also effectively conceal adhesive traces inside the tube body 22. The second tube body portion 222 is made of a material with a light-diffusing function such as plastic. This structural design also allows users to easily identify the light-emitting surface of the tube body 22.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, the emergency lighting device includes a tube body, two end caps, an input circuit and a load. The end caps are respectively disposed at two ends of the tube body. Each of the end caps includes a cylindrical body connected to the tube body and a cover detachably mounted on the cylindrical body. The input circuit has a first pin, a second pin, a third pin, and a fourth pin. The first pin, the second pin, the third pin, and the fourth pin are respectively disposed on the two end caps and connected to an external power source. The load is disposed inside the tube body and connected to the input circuit. Through the structural design of the detachable end caps, the user can conveniently maintain the emergency lighting device. Therefore, the maintenance of the emergency lighting device can be more convenient.

Also, according to one embodiment of the present invention, the emergency lighting device further includes a processing circuit and an emergency circuit. The processing circuit is connected to the input circuit. The emergency circuit is disposed inside one of the end caps, and connected to the processing circuit and the load. The emergency circuit includes a rechargeable battery, and the rechargeable battery is detachably disposed inside the cylindrical body. Through the integrated structure of the detachable end cap and the rechargeable battery, the user can directly remove the cover of the end cap and replace the rechargeable battery when the rechargeable battery is damaged, such that the emergency lighting device can function normally. Thus, the user can quickly replace a damaged rechargeable battery with a new one without discarding the emergency lighting device. Therefore, the emergency lighting device can significantly reduce the maintenance costs of the lighting system and meet actual requirements.

Further, according to one embodiment of the present invention, the emergency lighting device further includes a color temperature adjustment switch. The color temperature adjustment switch is connected to the processing circuit. The color temperature adjustment switch provides a color temperature adjustment function, such that the user can adjust the color temperature of the emergency lighting device by operating the switch to achieve the desired lighting effect. Therefore, the emergency lighting device can offer a wider range of color temperatures, so the emergency lighting device can be more comprehensive in application and flexible in use.

Moreover, according to one embodiment of the present invention, the load of the emergency lighting device may be a light source board, which includes a circuit board and a plurality of light sources. The circuit board may be a flexible circuit board, and the tube body may be a glass tube. The combination of the flexible circuit board and the glass tube can significantly reduce the difficulty of the manufacturing process for the emergency lighting device, thereby reducing labor costs. Therefore, the manufacturing cost of the emergency lighting device can be lowered.

Furthermore, according to one embodiment of the present invention, the emergency lighting device further includes a mode control switch, a mode control circuit, and a warning light. The mode control switch is disposed on one of the end caps and connected to the mode control circuit. The mode control circuit is disposed inside the tube body or one of the end caps and connected to the processing circuit. The warning light is disposed on one of the end caps and located below the mode control switch. The warning light is connected to the mode control circuit. The end cap has a light-transmitting groove, and the light-transmitting groove surrounds the mode control switch. This integrated design allows the light emitted by the warning light to directly pass through the light-transmitting groove and increases the light-emitting area of the warning light. Therefore, the user can quickly identify the status of the emergency lighting device based on the light emitted by the warning light.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An emergency lighting device with detachable end caps, comprising:
a tube body;
two end caps respectively disposed at two ends of the tube body, wherein each of the end caps comprises a cylindrical body connected to the tube body and a cover detachably mounted on the cylindrical body;
an input circuit having a first pin, a second pin, a third pin, and a fourth pin, wherein the first pin, the second pin, the third pin, and the fourth pin are respectively disposed on the two end caps and connected to an external power source; and
a load disposed inside the tube body and connected to the input circuit.

2. The emergency lighting device with detachable end caps as claimed in claim 1, wherein the input circuit is disposed inside the tube body or inside one of the end caps.

3. The emergency lighting device with detachable end caps as claimed in claim 1, further comprising a processing circuit and an emergency circuit, wherein the processing circuit is connected to the input circuit, and the emergency circuit is disposed inside one of the end caps and connected to the processing circuit and the load.

4. The emergency lighting device with detachable end caps as claimed in claim 3, wherein the emergency circuit comprises a rechargeable battery detachably disposed inside the cylindrical body.

5. The emergency lighting device with detachable end caps as claimed in claim 3, further comprising a color temperature adjustment switch connected to the processing circuit.

6. The emergency lighting device with detachable end caps as claimed in claim 3, further comprising a mode control switch and a mode control circuit, wherein the mode control switch is disposed on one of the end caps and connected to the mode control circuit, and the mode control circuit is disposed inside the tube body or inside one of the end caps and connected to the processing circuit.

7. The emergency lighting device with detachable end caps as claimed in claim 6, wherein the mode control switch is T-shaped.

8. The emergency lighting device with detachable end caps as claimed in claim 6, further comprising a warning light disposed on one of the end caps and located below the mode control switch, and the warning light being connected to the mode control circuit.

9. The emergency lighting device with detachable end caps as claimed in claim 8, wherein one of the end caps has a light-transmitting groove surrounding the mode control switch.

10. The emergency lighting device with detachable end caps as claimed in claim 1, wherein the load is a light source board, a light-emitting diode, or a light-emitting diode array.
